(19) United States
(12) Patent Application Publication
(10) Pub. No.: US 2016/0241070 A1
(43) Pub. Date: Aug. 18, 2016

(54) Energy-Storage Devices Having Integral Power-Management Units For Fast-Charging of Rechargeable devices

(71) Applicant: StoreDot Ltd., Herzeliya (IL)

(72) Inventors: Daniel Aronov, Netanya (IL); Leonid Krasovitsky, Rishon leZion (IL); Maxim Liberman, Haifa (IL); Vadim Sabayev, Rishon LeZion (IL); Leonid Spindler, Kefar Sava (IL)

(21) Appl. No.: 14/623,052

(22) Filed: Feb. 16, 2015

(51) Int. Cl. H02J 7/00; H02J 7/02

(52) U.S. Cl. CPC H02J 7/0054; H02J 7/025

(57) ABSTRACT

The present invention discloses integrated power-management units in energy-storage devices for fast-charging of rechargeable devices. Energy-storage devices include: an energy-storage component for providing power to a rechargeable device; and an integral power-management unit (PMU), integrally connected to the energy-storage component, for transforming a high-power input, having an input voltage and a low input RMS current, into a high-power output, having an output voltage and a high output RMS current, wherein the high-power input is equal to the high-power output, and wherein the high-power output is configured to charge the energy-storage component. Preferably, the PMU is configured to minimize resistive losses, wherein the resistive losses are designated as a mathematical product of the square of the high output RMS current (I_{RMS}²) and an output circuit resistance between the integral PMU and the energy-storage component, and wherein the mathematical product is symbolically defined as I_{RMS}²×R, associated with the high-power output.

### FIELD AND BACKGROUND OF THE INVENTION

The present invention relates to energy-storage devices (e.g., batteries and supercapacitors) having integral power-management units for fast-charging of rechargeable devices.

Modern electronic appliances are becoming ubiquitous for personal as well as business use. It cannot be overstated that with the evolution of such devices, mobility has emerged as a key driver in feature enhancement for technological innovation. The proliferation of smart phones, tablets, laptops, ultrabooks, and the like (acquiring smaller and smaller form factors) has made charging times a critical as consumers are eager to have longer and longer device usage times between recharge cycles, without adding heft to the weight and footprint of such devices. The same applies to any device (e.g., electrical vehicles and power tools) or application that uses an energy-storage device.

Most rechargeable-device chargers are not really chargers, but rather only power adaptors that provides a power source for the power management unit (PMU), which is usually contained within the rechargeable device. Rechargeable-device chargers are simply AC-to-DC converters. Such chargers convert an input of 86-260 Volts AC (RMS) into an output DC voltage. Rechargeable devices having an internal rechargeable cell, pack, or module (module consists from several packs, each pack consist from several cells) need to be charged with a DC voltage slightly higher than the battery voltage supplied by simple rechargeable-device chargers. The PMU is responsible for the charging mode (i.e., the current and voltage values for charging the energy-storage device).

Whenever an electric current flows through a material that has some resistance, heat is generated. Such resistive heating is the result of “friction,” as created by microscopic phenomena such as retarding forces and collisions involving the charge carriers (usually electrons); in formal terminology, the heat corresponds to the work done by the charge carriers in order to travel to a lower potential. Such heat generation may be intended by design, as in any heating appliance. Such an appliance essentially consists of a conductor whose resistance is chosen so as to produce the desired amount of resistive heating.

In other cases, resistive heating may be undesirable. Power lines are a classic example. The intended purpose is to transmit, not dissipate, energy; the energy converted to heat along the way is, in effect, lost. Resistive heating may be calculated by a simple formula P=I_{RMS}²×R, where P is the power, I_{RMS} is the current (wherein “RMS” denotes root mean square), and R is the resistance. Obviously, the power dissipated increases with increasing current and resistance. Importantly, resistive heating depends on the square of the current (i.e., the power is more sensitive to changes in current than resistance).

Therefore, at constant voltage, the effect of a change in current outweighs the effect of a corresponding change in resistance. There are other situations, however, in which the current rather than the voltage is constant. Transmission and distribution lines are an important example. In such cases, the reasoning described above does in fact apply, and resistive heating is directly proportional to resistance. The important difference between power lines and appliances is that for power lines, the current is unaffected by the resistance of the line itself. Instead, the current is determined by the load or power consumption at the end of the line.

However, the voltage drop along the line is unconstrained and varies depending on current and the line's resistance. Thus, Ohm's law still holds true, but the current is now fixed with V and R varying. Applying the formula P=I_{RMS}²×R for resistive heating under constant-current conditions, a doubling of the resistance of the power line will double resistive losses. A proper design topology allows for minimizing resistive losses, thereby reducing temperature rises upon power transmission.

Fast-charging of energy-storage devices requires applying higher currents, resulting in increases in resistive losses. Referring to the drawings, FIG. 1A is a simplified high-level schematic diagram of the system architecture for charging a rechargeable device having a rechargeable cell, pack, or module, according to the prior art. FIG. 1B is a simplified back view of an exemplary rechargeable device having a rechargeable cell, pack, or module, according to the prior art. A rechargeable device 2 is shown having an internal energy-storage cell 4 and a power-management unit (PMU) 6 operationally connected to an external power supply 8 when charging energy-storage cell 4.

The conventional design topology of FIG. 1A possesses two “interfaces.” Moving from the power source to rechargeable device 2, there is the supply/PMU interface between power supply 8 and PMU 6, and the PMU/cell interface between PMU 6 and energy-storage cell 4. Resistive losses can be reduced by increasing the voltage, resulting in a decrease in current. However, such a solution is applicable only to the supply/PMU interface. At the PMU/cell interface, the voltage is defined by energy-storage cell 4, and cannot be increased in order to reduce resistive losses. Therefore, a high current will be drawn by PMU 6 and energy-storage cell 4.

It would be desirable to have energy-storage devices having integral power-management units for fast-charging of rechargeable devices (e.g., a mobile device, cellular phone, smart phone, tablet computer, laptop PC, electric vehicle, or power tool). Such devices would, inter alia, overcome the various limitations mentioned above, and provide novel advantages to charger technology for rechargeable devices, including electric vehicles as well as supercapacitors.

### SUMMARY

It is the purpose of the present invention to provide energy-storage devices having integral power-management units for fast-charging of rechargeable devices.

It is noted that the term “exemplary” is used herein to refer to examples of embodiments and/or implementations, and is not meant to necessarily convey a more-desirable use-case. Similarly, the terms “preferred” and “preferably” are used herein to refer to an example out of an assortment of contemplated embodiments and/or implementations, and is not meant to necessarily convey a more-desirable use-case. Therefore, it is understood from the above that “exemplary” and “preferred” may be applied herein to multiple embodiments and/or implementations.

Preferred embodiments of the present invention enable high-current (or high-power) charging of energy-storage devices, while minimizing resistive losses, and reducing temperature rises at the electrical contacts. Specifically, such a design topology includes a power-management unit integrated into the energy-storage cell.

It is noted that such a power-management unit can include additional functionality associated with traditional PMUs. Such functionality includes, but is not limited to:

monitoring power connections and battery charges;

charging batteries when necessary;

controlling power to other integrated circuits;

shutting down unnecessary system components when the components are left idle;

controlling sleep and power functions (i.e., on and off);

managing the interface for built-in keypads and trackpads on portable computers; and

regulating the real-time clock (RTC).

Therefore, according to the present invention, there is provided for the first time an energy-storage device for fast-charging of rechargeable devices, the energy-storage device including: (a) an energy-storage component for providing power to a rechargeable device; and (b) an integral power-management unit (PMU), integrally connected to the energy-storage component, for transforming a high-power input, having an input voltage and a low input RMS current, into a high-power output, having an output voltage and a high output RMS current, wherein the high-power input is equal to the high-power output, and wherein the high-power output is configured to charge the energy-storage component.

Preferably, the PMU is configured to minimize resistive losses, wherein the resistive losses are designated as a mathematical product of the square of the high output RMS current (I_{RMS}²) and an output circuit resistance (R) between the integral PMU and the energy-storage component, and wherein the mathematical product is symbolically defined as I_{RMS}²×R, associated with the high-power output to a value selected from the group consisting of: less than about 5 W, less than about 3 W, less than about 1 W, less than about 0.5 W, and less than about 0.1 W.

Preferably, the high-power output is a wattage selected from the group consisting of: greater than about 20 W, greater than about 40 W, greater than about 60 W, greater than about 80 W, and greater than about 100 W.

Preferably, the high-power output is a wattage selected from the group consisting of: greater than about 300 W, greater than about 500 W, greater than about 1 kW, greater than about 100 kW, greater than about 500 kW, and greater than about 1 MW.

Preferably, the PMU is configured to receive the high-power input from a primary inductive coil, in an external power supply, via a secondary inductive coil in the rechargeable device.

Preferably, the energy-storage device further includes: (c) a secondary inductive coil configured to receive the high-power input from a primary inductive coil in an external power supply.

These and further embodiments will be apparent from the detailed description that follows.

### BRIEF DESCRIPTION OF THE DRAWINGS

The present invention is herein described, by way of example only, with reference to the accompanying drawings, wherein:

FIG. 1A is a simplified high-level schematic diagram of the system architecture for charging a rechargeable device having a rechargeable cell, pack, or module, according to the prior art;

FIG. 1B is a simplified back view of an exemplary rechargeable device having a rechargeable cell, pack, or module, according to the prior art;

FIG. 2A is a simplified high-level schematic diagram of the system architecture for charging a rechargeable device having an energy-storage device with an integral power-management unit, according to preferred embodiments of the present invention;

FIG. 2B is a simplified back view of an exemplary rechargeable device having an energy-storage device with an integral power-management unit, according to preferred embodiments of the present invention;

FIG. 3A is a simplified high-level schematic diagram of the system architecture for charging a rechargeable device having an energy-storage device with an integral power-management unit configured for inductive charging, according to preferred embodiments of the present invention;

FIG. 3B is a simplified back view of an exemplary rechargeable device having an energy-storage device with an integral power-management unit configured for inductive charging, according to preferred embodiments of the present invention.

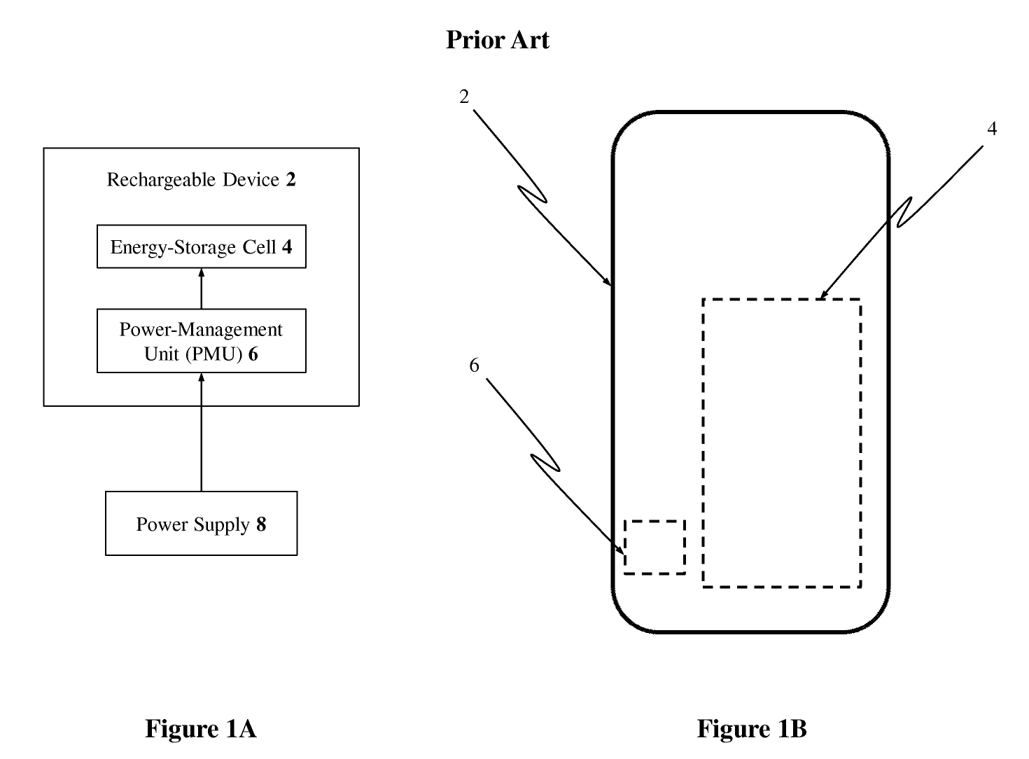

### DESCRIPTION OF THE PREFERRED EMBODIMENTS

The present invention relates to energy-storage devices having integral power-management units for fast-charging of rechargeable devices. The principles and operation for providing such devices, according to the present invention, may be better understood with reference to the accompanying description and the drawings.

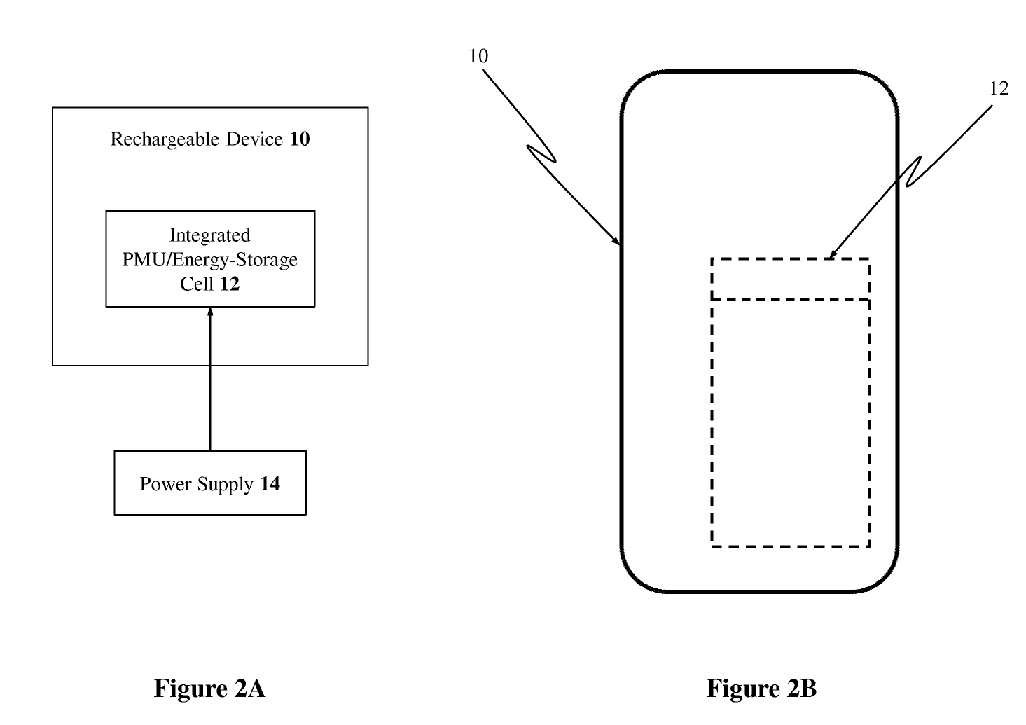

FIG. 2A is a simplified high-level schematic diagram of the system architecture for charging a rechargeable device having an energy-storage device with an integral power-management unit, according to preferred embodiments of the present invention. FIG. 2B is a simplified back view of an exemplary rechargeable device having an energy-storage device with an integral power-management unit, according to preferred embodiments of the present invention. A rechargeable device 10 is shown having an internal, integrated PMU/energy-storage cell 12 operationally connected to a power supply 14 when fast-charging integrated PMU/energy-storage cell 12. The PMU is an integral part of the energy-storage device, connected directly to the energy-storage cell. The design topology of FIG. 2A enables resistive losses to be minimized as described above.

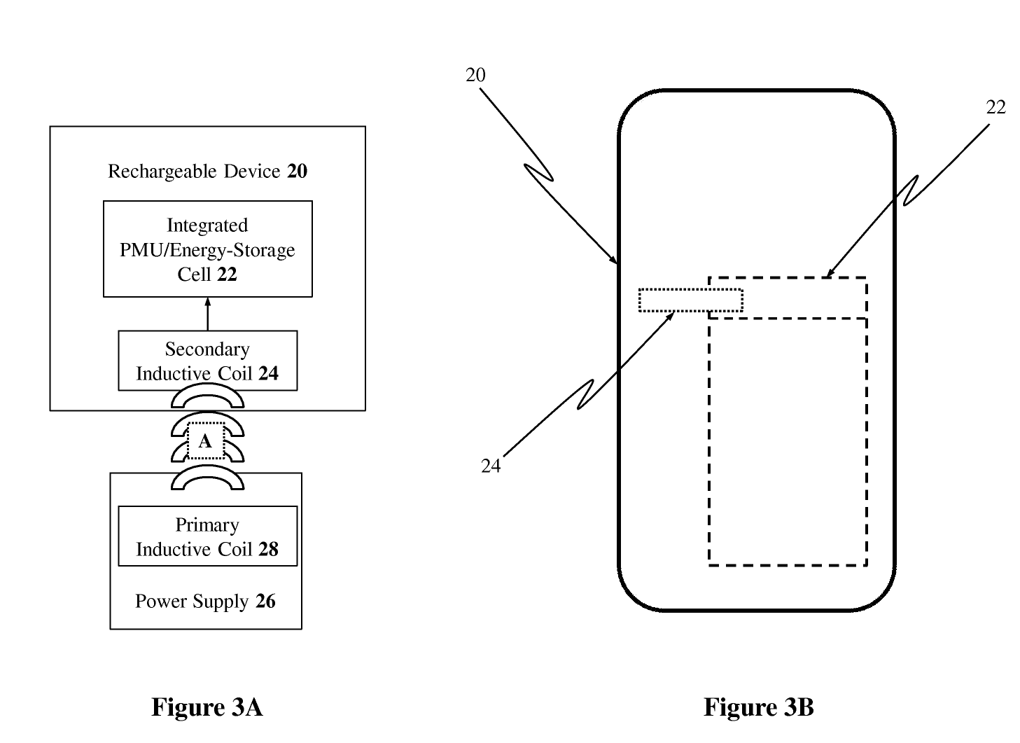

FIG. 3A is a simplified high-level schematic diagram of the system architecture for charging a rechargeable device having an energy-storage device with an integral power-management unit configured for inductive charging, according to preferred embodiments of the present invention. FIG. 3B is a simplified back view of an exemplary rechargeable device having an energy-storage device with an integral power-management unit configured for inductive charging, according to preferred embodiments of the present invention.

A rechargeable device 20 is shown having an internal, integrated PMU/energy-storage cell 22 and a secondary inductive coil 24 operationally connected to a power supply 26 having a primary inductive coil 28 when fast-charging integrated PMU/energy-storage cell 22. Primary inductive coil 28 delivers power to secondary inductive coil 24 via an inductive charging mechanism (Schematic Process A). The PMU is an integral part of the energy-storage device, connected directly to the energy-storage cell. The design topology of FIG. 3A enables resistive losses to be minimized as described above. Secondary inductive coil 24 may be located in rechargeable device 20 or in integrated PMU/energy-storage cell 22 as schematically represented in FIG. 3B.

While the present invention has been described with respect to a limited number of embodiments, it will be appreciated that many variations, modifications, and other applications of the present invention may be made.

1. An integrated power management and energy-storage cell unit for fast-charging of a rechargeable device, the integrated unit comprising:
an energy-storage cell; and
an integral power management unit (PMU), integrally and directly connected to said energy storage cell, for said PMU is configured to transform a high-power input having an input voltage and a low input RMS current, into a high-power output having an output voltage and a high output RMS current, said high-power output is greater than about 40 W, said integrated power management and energy-storage cell unit is embedded in a mobile device.

2. The integrated power management and energy-storage cell unit of claim 1, wherein said integrated unit is configured to minimize resistive losses between said integral PMU and said energy-storage cell to a value less than about 3 W.

3. The integrated power management and energy-storage cell unit of claim 1, wherein said high-power output is, greater than about 60 W.

4. (canceled)

5. The integrated power management and energy-storage cell unit of claim 1, wherein said PMU is configured to receive said high-power input from an inductive coil embedded in said mobile device.

6. (canceled)

7. The integrated power management and energy-storage cell unit of claim 1, wherein said high-power output is greater than about 80 W.

8. The integrated power management and energy-storage cell unit of claim 1, wherein said high-power output is greater than about 100 W.

9. The integrated power management and energy-storage cell unit of claim 1, wherein said integrated unit is configured to minimize resistive losses between said integral PMU and said energy-storage cell to a value less than about 1 W.

10. The integrated power management and energy-storage cell unit of claim 1, wherein said integrated unit is configured to minimize resistive losses between said integral PMU and said energy-storage cell to a value less than about 0.5 W.

11. The integrated power management and energy-storage cell unit of claim 1, wherein said integrated unit is configured to minimize resistive losses to a value less than about 0.1 W.

12. A mobile device comprising:
an integrated power management and energy-storage cell unit configured for fast-charging, integrated unit comprising:
an energy-storage cell; and
an integral power management unit (PMU), integrally and directly connected to said energy storage cell, said PMU is configured to transform a high-power input, having an input voltage and a low input RMS current, into a high-power output having an output voltage and a high output RMS current, wherein said high-power output is greater than about 40 W.

13. The mobile device of claim 12, wherein said high-power output is greater than about 60 W.

14. The mobile device of claim 12, wherein said high-power output is greater than about 80 W.

15. The mobile device of claim 12, wherein said high-power output is greater than about 100 W.

16. The mobile device of claim 12, wherein said integrated unit is configured to minimize resistive losses between said integral PMU and said energy-storage cell to a value less than about 3 W.

17. The mobile device of claim 12, wherein said integrated unit is configured to minimize resistive losses between said integral PMU and said energy-storage cell to a value less than about 1 W.

18. The mobile device of claim 12, wherein said integrated unit is configured to minimize resistive losses between said integral PMU and said energy-storage cell to a value less than about 0.5 W.

19. The mobile device of claim 12, wherein said integrated unit is configured to minimize resistive losses between said integral PMU and said energy-storage cell to a value less than about 0.1 W.

20. The mobile device of claim 12 further comprising an inductive coil and wherein said PMU is configured to receive said high-power input from said an inductive coil.

21. The mobile device of claim 12 further comprising:
a secondary inductive coil configured to receive said high-power input from a primary inductive coil in an external power supply.
